(19) United States
(12) Patent Application Publication
(10) Pub. No.: US 2024/0330103 A1
(43) Pub. Date: Oct. 3, 2024

(54) FAULT MESSAGE ACKNOWLEDGEMENT

(71) Applicant: WAGO Verwaltungsgesellschaft mbH, Minden (DE)

(72) Inventors: Daniel Janos MOEHLENBROCK, Werther (DE); Michael LANGREDER, Hessisch Oldendorf (DE)

(73) Assignee: WAGO Verwaltungsgesellschaft mbH, Minden (DE)

(21) Appl. No.: 18/742,892

(22) Filed: Jun. 13, 2024

Related U.S. Application Data
(63) Continuation of application No. PCT/EP2022/084378, filed on Dec. 5, 2022.

(30) Foreign Application Priority Data
Dec. 13, 2021 (DE) 10 2021 132 828.4

(51) Int. Cl. G06F 11/07; G06F 21/74

(52) U.S. Cl. CPC G06F 11/0793; G06F 11/0772; G06F 21/74

(57) ABSTRACT

A method for acknowledging an error message of an apparatus which transitions from an operating mode to a safe mode upon occurrence of an error. The method comprises receiving an acknowledgment request from the apparatus via a radio interface of a device, deriving data identifying the apparatus from the acknowledgment request by the device, and sending an acknowledgment message from the device to the apparatus via the radio interface.

This nonprovisional application is a continuation of International Application No. PCT/EP2022/084378, which was filed on Dec. 5, 2022, and which claims priority to German Patent Application No. 10 2021 132 828.4, which was filed in Germany on Dec. 13, 2021, and which are both herein incorporated by reference.

### BACKGROUND OF THE INVENTION

### Field of the Invention

The present invention relates to a method for acknowledging an error message of an apparatus which controls a system and, upon occurrence of an error, transitions from an operating mode to a safe mode in which the safe operation of the system is not in danger even if the error persists.

### Description of the Background Art

In automation, apparatuses are used to control or monitor safety-critical systems, which means that errors (which occur during the operation of the apparatuses) can pose a significant risk. Such apparatuses may therefore have special safety mechanisms which, for example, ensure that the apparatuses detect errors which occur during operation of the apparatuses and, when an error occurs, transition from an operating mode to a safe mode in which the error poses no danger or at least only a reduced danger (for example by bypassing states in which the error may affect the system). If the error no longer occurs, the apparatus may then return to operating mode. This return to the operating mode can occur automatically or, to increase safety, only after an error message has been acknowledged, thus enabling a user to check whether a safe return to the operating mode is possible and, if necessary, to take further action.

### SUMMARY OF THE INVENTION

A method according to the invention for acknowledging an error message of an apparatus which, upon occurrence of an error, transitions from an operating mode to a safe mode comprises receiving an acknowledgment request from the apparatus via a radio interface of a first device, deriving data identifying the apparatus from the acknowledgment request by the first device and sending a first acknowledgment message from the first device to the apparatus via the radio interface.

In this context, the term “acknowledgment”, can be understood, for example, as referring to the processing of an acknowledgment message, which causes the apparatus to return to the operating mode. Furthermore, the term “error message”, can be understood, for example, as referring to a message indicating that the apparatus has detected an error and, possibly, information about the error.

The message can be sent cyclically or acyclically by the apparatus and can be repeated or remain valid until the error is corrected. The error can be considered to be corrected, for example, if it is no longer detected by the apparatus. In this regard, it may be irrelevant whether the error was corrected as a result of user intervention or a correction routine of the apparatus or for any other reason. Once the error is corrected, the apparatus can send the acknowledgement request. The apparatus may be further configured to remain in the safe mode until a valid acknowledgement message is received, despite the error being rectified.

Furthermore, the term “radio interface”, can be understood, for example, as referring to a communication interface via which data can be received, and typically also sent, by radio. In addition, the term “data identifying the apparatus”, can be understood, for example, as referring to a unique identifier (such as an address) that is assigned to the apparatus.

The apparatus may be a head station or an I/O module of a modular fieldbus node. The head station or the I/O module may be used, for example, as a safety-related head station or as a safety-related I/O module which has specially developed and/or tested and/or redundant components.

In this regard, the term “module”, can be understood, for example, as referring to an apparatus which can be connected to another apparatus in order to extend the capabilities of the latter, wherein the other apparatus may be configured to be extended by a plurality of modules. To this end, a I/O module may have a housing which is designed to serially connect the I/O module to another I/O module or to the head station. The term “housing”, can be understood, for example, as referring to a structure made of a solid insulating material into which conductive structures are embedded, wherein the housing is typically designed in such a way that accidental contact with current-carrying conductors is prevented. Furthermore, the term “serially connecting”, can be understood, for example, as referring to the creation of a frictional or positive connection between housings, by means of which several modules can be connected to one another in series.

Furthermore, the term “I/O module”, can be understood to refer, for example, to an apparatus which is serially connectible or serially connected during operation to a head station and which connects one or more field devices with the head station and, potentially (via the head station) with a higher-level control unit. The term “head station”, can refer to a component of a modular fieldbus node whose task it is to make the data and/or services of the I/O modules which are connected to the head station available via the fieldbus to which the head station is connected.

The head station and the I/O module may be configured to exchange data by means of electrical signals over a wired transmission path (in particular a local bus). The term “local bus”, can be understood, for example, as referring to a bus via which (only) the I/O modules connected to the head station are (directly) connected to each another or to the head station. The I/O module may have a wired interface that is configured for exchanging data with the other I/O module or the head station. In this regard, the term “wired interface”, can be understood, for example, as a bus interface which is configured for connecting to the local bus.

The I/O module may have several inputs and/or outputs that are configured to read state signals and/or output control signals (control voltages and/or control currents). The I/O module may be configurable with regard to a derivation of the data from the state signals or a derivation of the control signals from the data (by a computer connected to the I/O module). The I/O module may further comprise a memory in which data can be stored from which the configuration of the I/O module can be derived. The configuration may, for example, determine how to generate process images (e.g., how to derive data from signals read at the inputs of the I/O module and how said data is to be transmitted via the local bus to the head station) and/or how to derive control signals (which are output, for example, at the outputs of the I/O module) from data transmitted from the head station via the local bus to the I/O module. The error message and/or the acknowledgement request may form part of a process image.

Field devices that provide state signals or process control signals may be connected to the inputs and/or outputs. In this regard, the term “field device”, can be understood, for example, as referring to a sensor or actuator connected (in terms of signaling) to the I/O module (e.g., electrically connected to the I/O module). Furthermore, the terms “input” and “output” can be understood, for example, as referring to electrical connections. It may be that voltages and/or currents at inputs of an I/O module are generated by other devices and voltages and/or currents at outputs of an I/O module are generated by the I/O module itself.

Furthermore, the term “computer”, can be understood, for example, as referring to an electronic device which has a processor and a non-volatile memory with instructions stored in the memory which when processed by the processor constitute the execution of a program which serves to represent and/or manage a fieldbus system comprising the I/O module. The term “memory”, can be understood, for example, as referring to an electronic memory. The computer may be configured, for example, for user-initiated parameterization of the I/O module. The parameterization can be carried out, for example, as part of the configuration (or reconfiguration) of the I/O module. For example, a user or commissioning engineer may set the parameters using the computer and transfer them to the I/O module via the head station or the radio interface.

The receipt of the first acknowledgement message may cause the apparatus to return to the operating mode. The return to the operating mode may, for example, involve a restart of the apparatus. Restarting the apparatus may correspond to executing a routine that would be executed if the device is restarted after a (possibly short-term) interruption of the power supply.

The apparatus may send another acknowledgment request via a wired connection to a second device and return from the safe mode to the operating mode in response to receiving a second acknowledgment message from the second device, wherein the apparatus ignores acknowledgment messages received while the apparatus is in the operating mode.

For example, the apparatus may send the acknowledgement request via the local bus to the head station and/or via the fieldbus to the higher-level control unit. The higher-level control unit may then acknowledge the error message or, if an inspection appears necessary or useful, request an acknowledgement through the first device.

Deriving data identifying the apparatus may include decrypting the acknowledgement request.

The first acknowledgement message may be encrypted using a key associated with the apparatus.

The first device may be a portable device. The portable device may be a mobile computer, e.g. in the form of a mobile phone, tablet or laptop.

An apparatus according to the invention comprises a radio interface and a circuit, wherein the circuit is configured to control a system, wherein the apparatus is configured to transition, upon occurrence of an error, from an operating mode to a safe mode in which the safe operation of the system is not in danger despite the presence of the error, wherein the circuit is further configured to send an acknowledgment request via the radio interface when the error is rectified and wherein the apparatus is further configured to return from the safe mode to the operating mode in response to the receipt of a valid acknowledgment message.

In this regard, the term “circuit”, can be understood, for example, as referring to a combination of electrical and electronic components forming a functional unit. The components may, for example, be arranged on a circuit board or formed in a semiconductor chip. Furthermore, the term “valid acknowledgment message”, can be understood, for example, as an acknowledgment message which is provided with information which allows the correctness of the acknowledgment message to be verified. For example, the acknowledgment message may be encrypted and/or transmitted over redundant channels so that the correctness of the acknowledgment messages can be verified by comparison.

The apparatus may further comprise a wired interface, wherein the circuit is further configured to send another acknowledgment request via the wired interface when the error occurs, and wherein the apparatus is further configured to return from the safe mode to the operating mode in response to receiving a valid acknowledgment message via the wired interface.

The apparatus may be further configured to ignore invalid acknowledgement messages and valid acknowledgement messages received while the apparatus is in the operating mode. For example, the circuit may be configured to verify whether the acknowledgement message was received from a sender that belongs to a certain sender group and ignore all acknowledgement messages from senders that do not belong to the group. In addition, the circuit may be configured to check whether the acknowledgment message contains any impermissible changes and ignore any acknowledgment messages containing any impermissible changes.

The circuit may be configured to decrypt acknowledgment messages with a key and the apparatus may be further configured to return from the safe mode to the operating mode only if one of the acknowledgment messages can be decrypted with the key.

The decrypted acknowledgement message may, for example, contain data regarding the sender and a checksum that can be used to verify the integrity of the acknowledgement message.

The apparatus may further be configured to send copies of the process images to the portable device via the radio interface and/or to receive control data from the portable device. The entire communication between the apparatus and the portable device may be encrypted.

A portable device according to the invention comprises a radio interface and a circuit, wherein the circuit is configured to receive an acknowledgment request from an apparatus via the radio interface, to display the acknowledgment request to a user of the portable device, to encrypt an acknowledgment message with a key associated with the apparatus in response to a user request, and to send the encrypted acknowledgment message to the apparatus via the radio interface.

The portable device may be further configured to decrypt the acknowledgement request.

It is understood that all steps carried out when using the apparatus and the portable device may also be features of the corresponding method and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of a fieldbus system;

FIG. 2 shows a schematic illustration of a fieldbus node of the fieldbus system shown in FIG. 1;

FIG. 3 illustrates the configuration of the fieldbus node shown in FIG. 2 by a computer connected to the fieldbus node;

FIG. 4a illustrates the receipt of an acknowledgement request by a portable device;

FIG. 4b illustrates the acknowledgement of an error message by the portable device;

FIG. 5a illustrates the reception of an acknowledgement request by a stationary device;

FIG. 5b illustrates the acknowledgement of an error message by the stationary device; and

FIG. 6 shows a flow chart of a method for acknowledging an error message.

### DETAILED DESCRIPTION

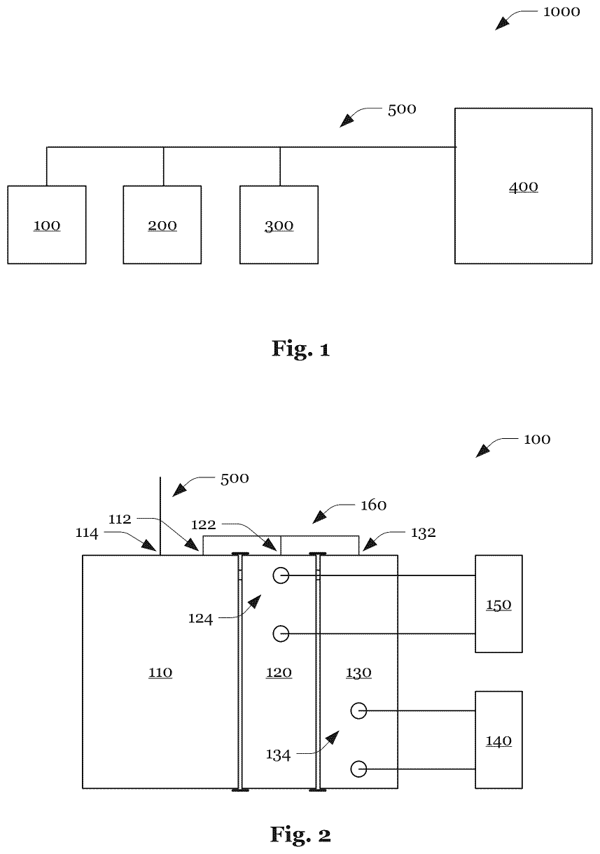

FIG. 1 shows a block diagram of fieldbus system 1000. Fieldbus system 1000 includes fieldbus nodes 100, 200, 300 and 400, which are interconnected via fieldbus 500. Fieldbus node 400 is a higher-level control unit and can be used both for monitoring and for controlling a plant that is controlled by fieldbus system 1000. When higher-level control unit 400 monitors a plant, higher-level control unit 400 can cyclically or acyclically receive state data describing the state of the plant from one or more of fieldbus nodes 100, 200 and 300 and generate an alarm signal if the state of the plant deviates (substantially) from a desired/permitted state or state range.

If higher-level control unit 400 (not only monitors but also) controls the plant, higher-level control unit 400 can cyclically or acyclically receive state data from one or more of fieldbus nodes 100, 200 and 300 and, taking the state data into account, determine control data that is transmitted to one or more of fieldbus nodes 100, 200 and 300.

FIG. 2 illustrates the modular fieldbus node 100, formed of head station 110 and two I/O modules 120 and 130 connected to head station 110, to which sensor 140 and actuator 150 are connected. During operation, I/O module 130 reads sensor signals via input 134 and generates state data from the sensor signals, which are transmitted via interface 132, local bus 160, and interface 112 to head station 110. Head station 110 may include, in addition to (fieldbus) interface 114, a processor and a memory in which information regarding a configuration of head station 110 is stored.

The information regarding the configuration of head station 110 may, for example, specify which or how many I/O modules are connected to head station 110 and how head station 110 should handle the received state data. Head station 110 may, for example, process the state data locally and/or forward it (possibly in modified form) to higher-level control unit 400 via interface 114 and field bus 500. Higher-level control unit 400 (or head station 110 in the case of local processing) may then generate control data taking the state data into account.

The control data generated by the higher-level control unit 400 may then be transmitted to head station 110 via field bus 160. The control data transmitted to head station 110 (or generated by head station 110) are then forwarded/transmitted (possibly in modified form) to I/O module 120. I/O module 120 receives the control data and outputs control signals corresponding to the control data to output 124 to which actuator 150 is connected. The communication of data between the components of fieldbus system 1000 and the mapping of sensor signals to state data and the mapping of control data to control signals can be adapted to different application scenarios by configuring fieldbus nodes 100.

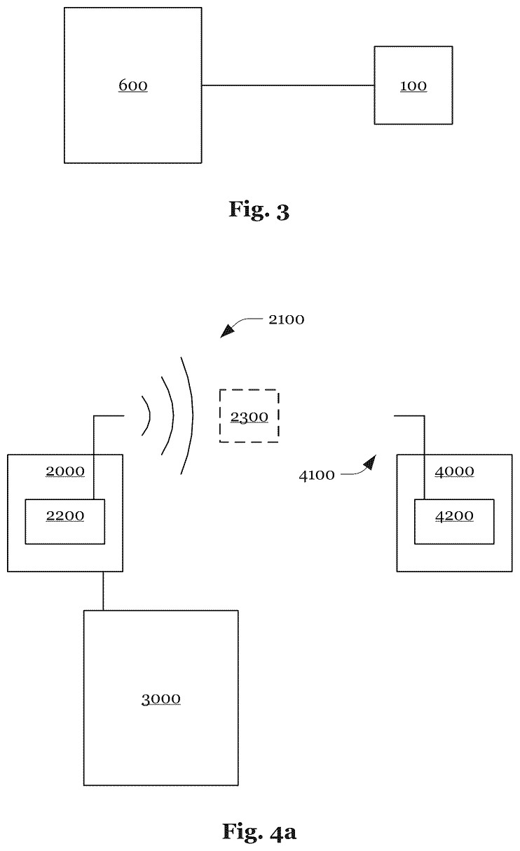

FIG. 3 shows fieldbus node 100 and computer 600 connected to fieldbus node 100 (e.g. a desktop, a laptop, a tablet, etc.), which is set up to configure I/O module 120 and I/O module 130 of fieldbus node 100. Computer 600 may serve solely or primarily for configuration and may also perform other tasks (in addition to configuration). For example, computer 600 may be part of the higher-level control unit 400 and, in addition to configuration, may also perform monitoring and/or control tasks. For example, computer 600 may monitor the plant and be configured to switch from a first operating mode to a second operating mode when certain conditions are fulfilled (and to change or update the configuration, if necessary, during the switchover).

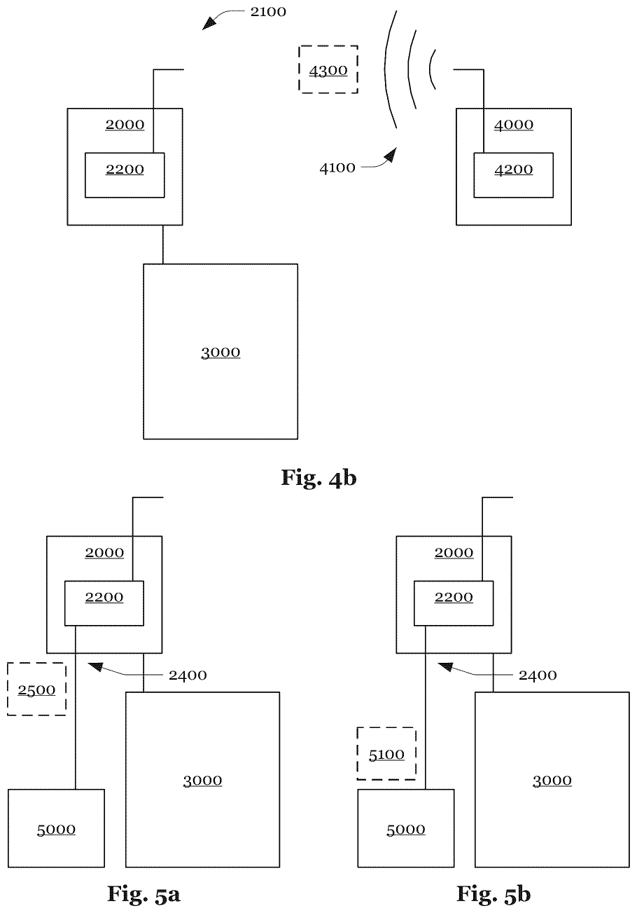

FIG. 4a shows apparatus 2000, which may be, for example, field bus node 100, head station 110, I/O module 120, I/O module 130, sensor 140, actuator 150, or higher-level control unit 400. Apparatus 2000 comprises radio interface 2100 and circuit 2200. Circuit 2200 is configured to control plant 3000. If apparatus 2000 is in an operating mode and detects an error, apparatus 2000 transitions from the operating mode to a safe mode in which the safe operation of the system is not at risk despite the presence of the error. If apparatus 2000 is head station 110, for example, and detects that sensor 140 is defective, head station 110 may provide an artificially generated senor signal and indicate to plant 3000 that sensor 140 is defective instead of providing the (possibly incorrect) sensor signal so that no damage can result from the error.

When the error occurs, circuit 2200 issues an error message. Furthermore, circuit 2200 may take measures to correct the error. If the error is corrected (either by an action by apparatus, by user intervention, or because the cause of the error was temporary), circuit 2200 issues an acknowledgement request 2300 via radio interface 2100. For example, circuit 2200 may send acknowledgement request 2300 to portable device 4000 in response to establishing a communication channel with portable device 4000. For example, the portable device 4000 may establish a radio channel to device 2000 based on a short-range radio standard (such as standardized in IEEE 802.11, IEEE 802.15, etc.) and identify itself during the connection establishment. Circuit 2200 may then (after the connection has been established and, if applicable, after identification has taken place) send the (if applicable, signed and/or encrypted) acknowledgement request 2300 to the portable device 4000.

The portable device 4000, similar to the apparatus 2000, comprises a radio interface 4100 and a circuit 4200 that enable the portable device 4000 to receive and process the acknowledgement request 2300. For example, the portable device 4000 may be configured to decrypt the acknowledgement request 2300 (if the acknowledgement request 2300 is encrypted), verify the signature of the acknowledgement request 2300 (if the acknowledgement request 2300 includes a signature), identify the apparatus 2000 (e.g., using the signature or an address of the apparatus 2000 attached to the acknowledgement request 2300), and display the acknowledgement request 2300 to a user of the portable device 4000. Displaying the acknowledgement request 2300 may, for example, include displaying an error code and an identification of the apparatus 2000. Displaying the acknowledgement request 2300 may also include a request to acknowledge the error.

If the user of the portable device 4000 acknowledges the error (e.g. via an input using a touch-sensitive display or a button of the portable device 4000), circuit 4200 generates acknowledgment message 4300 and sends acknowledgment message 4300, as illustrated in FIG. 4b, to apparatus 2000 via radio interface 4100. To increase the security when acknowledging error messages, the acknowledgment message 4300 can be encrypted and/or include a signature. The apparatus 2000 may decrypt the received acknowledgment message 4300 and verify the sender of the acknowledgment message 4300 based on the signature. Furthermore, the apparatus 2000 may verify the validity of the received acknowledgment message 4300 based on a checksum. If the received acknowledgement message is 4300 valid, the apparatus 2000 may return to the operating mode. When returning to the operating mode, the apparatus 2000 may, for example, replace (safe) standard values with calculated values.

As illustrated in FIG. 5a, apparatus 2000 may be connected to another device 5000 via a wired interface 2400 and send another acknowledgement request 2500 to the other device 5000 when the error occurs. If the apparatus 2000 receives an acknowledgement message 5100 from the further device 5000, as illustrated in FIG. 5b, the apparatus 2000 may return from the safe mode to the operating mode.

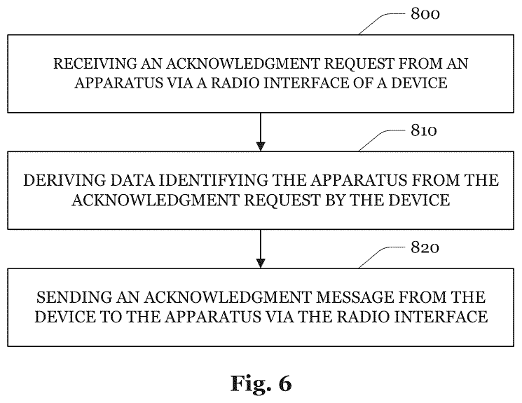

FIG. 6 shows a flow chart of the method for acknowledging the error message. The process begins at step 800 with the receipt of the acknowledgement request 2300 of the apparatus 2000 via the radio interface 4100 of the portable device 4000. Then, at step 810, data are derived from the acknowledgement request 2300 which identify the apparatus 2000. At step 820, an acknowledgement message 4300 is sent from the portable device 4000 to the apparatus 2000, causing the apparatus 2000 to return from the safe mode to the operating mode.

What is claimed is:

1. A method for acknowledging an error message of an apparatus which, upon occurrence of an error, transitions from an operating mode to a safe mode, the method comprising:
receiving an acknowledgment request of the apparatus via a radio interface of a first device;
deriving data identifying the apparatus from the acknowledgement request by the first device; and
sending a first acknowledgement message from the first device to the apparatus via the radio interface.

2. The method according to claim 1, wherein the receipt of the first acknowledgment message causes the apparatus to return to the operating mode.

3. The method according to claim 1, wherein the apparatus sends another acknowledgment request via a wired connection to a second device and returns from the safe mode to the operating mode in response to receiving a second acknowledgment message from the second device, and wherein the apparatus ignores acknowledgment messages received while the apparatus is in the operating mode.

4. The method according to claim 1, wherein deriving data identifying the apparatus comprises decrypting the acknowledgement request, and/or wherein the first acknowledgement message is encrypted using a key associated with the apparatus.

5. The method according to claim 1, wherein the first device is a portable device.

6. An apparatus comprising:
a radio interface; and
a circuit configured to control a system,
wherein the apparatus is configured to transition, upon occurrence of an error, from an operating mode to a safe mode in which the safe operation of the system is not in danger despite the presence of the error,
wherein the circuit is configured to send an acknowledgement request via the radio interface upon rectification of the error, and
wherein the apparatus is configured to return from the safe mode to the operating mode in response to receiving a valid acknowledgment message.

7. The apparatus according to claim 6, further comprising:
a wired interface,
wherein the circuit is further configured to send another acknowledgement request via the wired interface upon rectification of the error; and
wherein the apparatus is further configured to return from the safe mode to the operating mode in response to receiving a valid acknowledgment message via the wired interface.

8. The apparatus according to claim 6, wherein the circuit is further configured to ignore invalid acknowledgement messages and valid acknowledgement messages received while the apparatus is in the operating mode.

9. The apparatus according to claim 6, wherein the circuit is configured to decrypt acknowledgment messages with a key, and wherein the apparatus is further configured to return from the safe mode to the operating mode only if one of the acknowledgment messages is adapted to be decrypted with the key.

10. A portable device comprising:
a radio interface; and
a circuit, the circuit being configured to receive an acknowledgement request from an apparatus via the radio interface, and configured to display the acknowledgement request to a user of the portable device, in response to a user request, encrypt an acknowledgement message with a key associated with the apparatus, and send the encrypted acknowledgement message to the apparatus via the radio interface.
